(19) United States
(12) Patent Application Publication
(10) Pub. No.: US 2006/0180273 A1
(43) Pub. Date: Aug. 17, 2006

(54) Method for splicing a multilayer papermachine fabric

(76) Inventor: David Beck, Appleton, WI (US)

Correspondence Address: VOITH FABRICS, 3040 BLACK CREEK ROAD, P.O. BOX 1411, WILSON, NC, 27893, US

(21) Appl. No.: 11/302,740

(22) Filed: Dec. 13, 2005

Related U.S. Application Data
(60) Provisional application No. 60/637,021, filed on Dec. 17, 2004.

(51) Int. Cl. B32B 37/00

(52) U.S. Cl. 156/304.3; 156/304.5; 156/304.6; 156/152

(57) ABSTRACT

A method for splicing a multilayer papermachine fabric, in particular a papermachine wire, by first separating the layers from each other in the region of the free ends of the layers. The free ends of the respective layer are joined by means of at least partial mutual fusing of the free ends of the respective layer; arranging a reinforcing strip covering the joints of the layers between the layers; and mutually joining the reinforcing strip and the layers.

### CROSS-REFERENCE TO RELATED APPLICATIONS

The present application claims priority under 35 U.S.C. §119 of Provisional U.S. Patent Application No. 60/639,021 filed on Dec. 17, 2004, the disclosure of which is expressly incorporated by reference herein in its entirety.

### BACKGROUND OF INVENTION

1. Field of the Invention

The invention relates to a method for splicing a multilayer papermachine fabric. More particularly, the invention relates to a method for splicing a multilayer papermachine fabric having a first layer and a second layer wherein the first layer has a first and second free end and the second layer has a third and fourth free end, in which the free ends of the first layer and the free ends of the second layer are joined to each other at a first joint are and a second joint area, respectively,

2. Discussion of Background Information

Papermachine fabrics are produced either closed or endless or open. In the second case, the two longitudinal ends are then joined to each other on the paper machine in order to produce an “endless fabric”. Practice reveals a plurality of methods for splicing such a papermachine fabric. During the fabrication of an endless fabric, during its production, for example, the free ends are interwoven in an endless manner, by hand or by machine. Such a method is always very time-consuming and therefore expensive. In addition, joining the longitudinal ends of a fabric on the paper machine is difficult and time-consuming.

### SUMMARY OF THE INVENTION

The invention is based on the object of providing a method in which the splicing of a multilayer papermachine fabric can be carried out more economically.

According to the invention, this object is carried out by separating the first layer from the second layer in the region of the free ends; joining the first and second free ends by means of at least partial mutual fusing of the free ends and joining the third and fourth free ends by means of at least partial mutual fusing of the free ends; (c) arranging a reinforcing strip covering the first joint are and the second joint area between the first and second layers; and mutually joining the reinforcing strip and the first and second layers.

Additional advantageous developments are recited below.

According to the invention, the layers are separated from one another in the region of their respective free ends, the free ends of the respective layer are then joined by means of at least partial mutual fusing, a reinforcing strip covering the joints of the layers is then arranged between layers and, finally, reinforcing strip and layers are joined to one another. It is advantageous here that such a method can be carried out simply and quickly and, above all, even when the fabric has been laid in the paper machine. The seam or joint can be designed to be stronger than the rest of the fabric and can have a permeability which is approximately identical to that of the rest of the fabric. In addition, such a joining region can have approximately the same thickness as the rest of the fabric, so that the marking of the paper web is minimal. The mutual fusing or initial melting of the free ends of the respective layer is therefore primarily used to join the free ends of the relevant layer to each other, whereas the reinforcing strip covering the joints is used to ensure the necessary strength, in particular tensile and tearing strength.

The mutual fusing of the free ends of the respective layer is advantageously carried out by applying pressure and/or temperature, preferably a temperature of about 350° C. At such a temperature, it is ensured that the fabric melts and, to this extent, joining of the free ends to each other is made possible. It is clear that, in the case of a two-layer papermachine fabric, both outside layers, namely the free ends of the upper layer and the free ends of the lower layer, are in each case joined to each other.

According to a preferred embodiment of the invention, the free ends of the respective layer are arranged top side to top side in order to carry out the joining by means of mutual fusing, projecting sections of the free ends on the other side of the joint of the respective layer preferably being cut off when the joining operation is carried out. Therefore, firstly, at least linear fusing of the respective two free ends to be joined and, secondly, a clean termination of the free ends is at least made possible. Method steps of this type can be carried out relatively easily and without difficulty. The mutual fusing of the free ends is particularly preferably carried out at least at the line of contact of the two free ends as the aforementioned projecting sections on the other side of the joint are cut off or severed. Such a cut or such a separation supplies an “end point” which is easy to observe for the mutual joining of the free ends of each layer. As soon as the free ends joined to each other have cooled down after the separation or cut has been carried out, a method of this type supplies an effective joint, so that the method can ultimately be carried out very cost-effectively and therefore economically.

According to another embodiment of the invention, the mutually joined ends of the respective layer are subjected to a smoothing treatment in the region of the respective joint before the next following step is carried out, which smoothing treatment is preferably carried out by applying pressure and temperature by means of flat pressing the mutually joined ends in the region of the respective joint and, preferably, with renewed initial melting of the layer in this region. To this extent, after the smoothing treatment has been carried out, a flat, uniform, spliced papermachine fabric will be obtained. Any warped or buckled areas which are present before the smoothing treatment are effectively eliminated after the smoothing treatment, so that ultimately a flat joining region can be obtained. This smoothing treatment can be carried out in that, in addition, a low tension of, for example, 1 pli (pounds per linear inch) or less is applied to the joining region in opposite directions and the aforementioned pressure and temperature are then applied. In addition, it is possible to redistribute the molten or initially molten fabric in the region of the respective joint, in order to obtain a joining region which is even flatter. It is particularly advantageous in this case that the method according to the invention can be carried out easily and can preferably progress on the paper machine.

According to another embodiment of the invention, the reinforcing strip is fabricated from a polymeric aromatic aramide such as Kevlar® or the like, preferably with a thickness of about 90 μm (0.0035 inch). A reinforcing strip of this type increases the strength in the region of the joints, so that it is possible to obtain a fabric which has adequate strength even in the region of the joints. The reinforcing strip, as previously mentioned, bridges over the respective joints and in this way transmits the mechanical loading from one side of the joint to the other side of the joint. In this case, the reinforcing strip is designed to be thin, in such a way that its incorporation into the papermachine fabric will only affect its thickness to an inconsiderable extent. The reinforcing strip can be a surface-like textile structure, so that, as a result, the permeability of the fabric is barely affected either.

The joints of the individual layers are preferably offset by at least 7.5 cm (3 inches) from one another. This procedure can offer advantages in relation to the strength of the spliced fabric, since a joint in one layer is then always opposite a continuous, uniform, not mutually joined part in the other layer.

According to another embodiment of the invention, the layers are joined to one another by means of a perforated adhesive layer. The perforated adhesive layer preferably has a carrier layer of BOPET, such as Mylar®. The adhesive layer is preferably laminated onto the upper side of the reinforcing strip. A hot-melt adhesive inlay is preferably applied to the underside of the reinforcing strip in order to join the reinforcing strip to one of the layers. The adhesive layer therefore has an adhesive upper side and an adhesive underside and, if it is located between two layers, is capable of joining these layers firmly to each other. If the permeability of the fabric is affected negatively by the hot-melt adhesive inlay, it is also possible to leave out the perforated adhesive layer on the upper side of the reinforcing strip. This can be done primarily when the reinforcing strip is adhesive at least on its upper side. The hot-melt adhesive inlay is preferably the product Rototherm®.

The reinforcing strip preferably covers each of the joints assigned to it on both sides by at least 7.5 cm (3 inches) in each case. In the case of a joining region in which the joints of two layers are offset by 7.5 cm from one another, the result for the reinforcing strip is therefore a total length of 3×7.5 cm, that is to say about 22.5 cm. With the aid of a method of this type, the necessary forces can readily be transmitted permanently, even in the region of the joints. It can even be the case that the strength in the region of the joints is higher than in the remaining region of the fabric. The joining region is stretched only insignificantly during operation of the paper machine, so that the fabric has a long lifetime, at least in this region. From this, it also follows that the method according to the invention is ultimately very economical.

### BRIEF DESDCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic side view of part of a papermachine fabric in the region of its free ends;

FIG. 2 shows a schematic side view of part of the papermachine fabric following at least partial mutual fusing of the free ends;

FIG. 3 shows a schematic side view of the spliced, smoothed papermachine fabric; and

FIG. 4 shows a schematic, exploded, partial side view of the spliced, multilayer papermachine fabric, having two layers in the exemplary embodiment shown.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

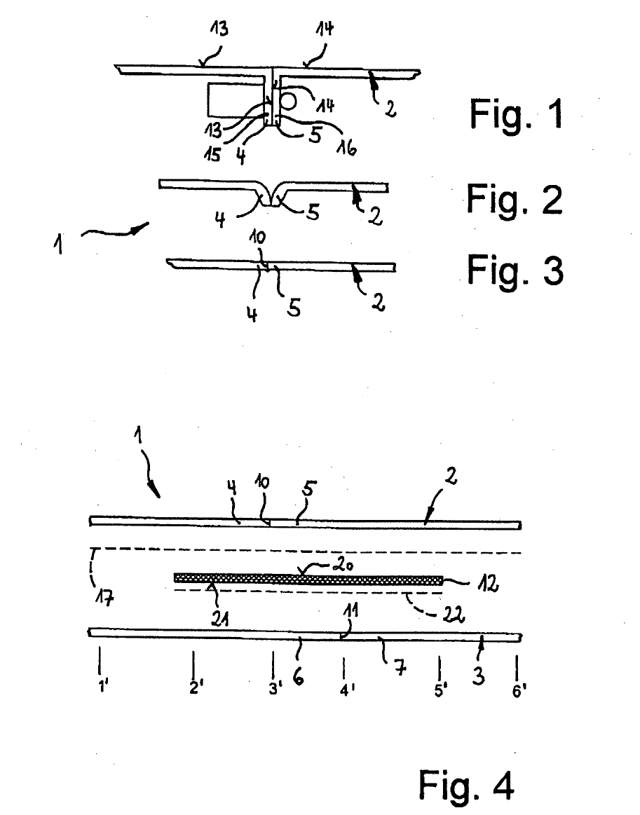

The method according to the invention for splicing a multilayer papermachine fabric 1, in particular a paper machine wire, will be explained in more detail below with reference to FIGS. 1 to 4. Here, FIGS. 1 to 3 relate to one of the layers of the papermachine fabric 1. In contrast, FIG. 4 shows a multilayer, specifically two-layer, papermachine fabric 1 having a first or top layer 2 and a second or bottom layer 3 in the spliced state. FIGS. 1 to 3 show the splicing of one layer of the papermachine fabric 1.

By way of example, it will be assumed that, in FIGS. 1 to 3, the splicing of the first, top layer 2 of the papermachine fabric 1 is shown. The layer 2 has free ends, namely, according to FIGS. 1 to 3, a left-hand free end 4 and a right-hand free end 5, which are joined to each other with the aid of the method according to the invention.

Likewise, the bottom layer 3 according to FIG. 4 has a left-hand free end 6 and a right-hand free end 7. In the spliced state according to FIGS. 3 and 4, each layer 2, 3 has a joint 10, 11.

According to the invention, the method comprises the following steps:

(a) separating the layers 2, 3 from each other in the region of the free ends 4, 5; 6, 7;

(b) joining the free ends 4, 5; 6, 7 of the respective layer 2, 3 by means of at least partial mutual fusing of the free ends 4, 5; 6, 7 of the respective layer 2, 3;

(c) arranging a reinforcing strip 12 covering the joints 10, 11 of the layers 2, 3 between layers 2, 3;

(d) mutually joining the reinforcing strip 12 and layers 2, 3.

The mutual fusing of the free ends 4, 5; 6, 7 of the respective layer 2, 3 in the aforementioned step (b) is carried out with the local application of pressure and temperature, preferably a temperature of about 350° C.

Following the separation of the layers from each other in step (a), the free ends 4, 5 of the respective layer 2, 3 are arranged with top side 13 overlapping top side 14, as is shown by way of example in FIG. 1 in relation to the first, top layer 2, in order to carry out step (b). Preferably, when carrying out the aforementioned step (b), projecting sections 15, 16 of the free ends 4, 5 on the other side of the joint 10, 11 of the respective layer 2, 3 are cut off.

At the end of step (b), the ends 4, 5 of the layer 2 joined to each other according to FIG. 2 are subjected to a smoothing treatment in the region of the respective joint; this is the joint 10 in the exemplary embodiment according to FIGS. 1 to 3, before carrying out steps (c) and (d). This smoothing treatment is carried out by applying pressure and temperature by means of flat pressing the mutually joined ends 4, 5 and 6, 7 in the region of the respective joint 10, 11 and preferably with renewed initial melting of the layer 2 or 3 in this region.

After the end of the smoothing treatment, the result is then the spliced layer 2 of the papermachine fabric 1 shown in FIG. 3. The at least partial mutual fusing of the free ends according to step (b), which is shown by way of example in FIG. 2, can be what is known as linear fusing, whereas, after the smoothing treatment and the preferably renewed initial melting of the layers in the region of their free ends, ultimately a more two-dimensional fusing of the free ends to each other is carried out, as indicated in FIG. 3 at the joint 10 of the layer 2.

According to a preferred embodiment of the invention, the reinforcing strip 12 is fabricated from Kevlar, preferably with a thickness of approximately 90 μm (0.0035 inch). A reinforcing strip of this type has a relatively high strength and can therefore be used to transfer the forces occurring at a free end of each layer via the joint of the respective layer to the other free end of the respective layer without the total strength of the papermachine fabric suffering from this.

As shown in FIG. 4, the joints 10, 11 of the individual layers 2, 3 are preferably offset by at least 7.5 cm (3 inches) from one another. From this, it follows that, in FIG. 4, the joints 10, 11 are not arranged vertically above one another but, as previously mentioned, offset from one another. This can be carried out in that, before the mutual joining of the ends, one free end of one layer and the other free end of the other layer, which other free end of the other layer is approximately diagonally opposite the free end of the one layer, are shortened by the same amount.

As further illustrated in FIG. 4, the layers 2, 3 of the papermachine fabric 1 are joined to each other by means of a perforated adhesive layer 17, which is preferably applied to a carrier layer of Mylar®. This perforated adhesive layer is illustrated dashed in FIG. 4. The perforated adhesive layer 17 having the Mylar® carrier layer is therefore located centrally between the two layers, it is provided with adhesive on both sides and therefore permits a firm join between the layers 2 and 3.

As shown in FIG. 4, the perforated adhesive layer 17 is laminated onto the upper side 20 of the reinforcing strip 12. Furthermore, a hot-melt adhesive inlay 22 is applied to the underside 21 of the reinforcing strip in order to join the reinforcing strip 12 to the bottom layer 3 in FIG. 4. In FIG. 4, the hot-melt adhesive inlay 22 is also merely illustrated dashed. This hot-melt adhesive inlay 22 is an open-mesh adhesive layer and is intended not to block the air stream through the papermachine fabric 1 as compared with the perforations in the perforated adhesive layer 17 having the Mylar® carrier layer, so that the influence of this additional, hot-melt adhesive inlay 22 is minimal. This hot-melt adhesive inlay is, for example, a product which can be obtained under the name Rototherm®. Should this Rototherm® adhesive inlay 22 hinder or block the air stream, the perforated adhesive layer 17 having the Mylar® carrier layer over the length of the reinforcing strip 12 can be dispensed with. In this case, the reinforcing strip 12 with adhesive upper side 20, together with the Rototherm® adhesive inlay, would then have the same permeability as the adhesive layer 17.

In FIG. 4, the individual positions along the joining region of the papermachine fabric 1 are identified by the designations 1′ to 6′. The aforementioned sectional omission of the Mylar® adhesive layer 17 could accordingly be made in the region of the positions 2′ to 5′.

According to a preferred embodiment of the invention, the reinforcing strip 12 covers each of the joints 10, 11 assigned to it on both sides by at least 7.5 cm (3 inches) in each case. The result, if the joints 10, 11 of the layers 2, 3 are also offset by approximately 7.5 cm (3 inches) from one another, is an overall length of the reinforcing strip of 3×7.5 cm, i.e. 22.5 cm (about 9 inches) within the positions 2′ to 5′.

Practical trials have shown that the provision of the Kevlar reinforcing strip improves the strength of the fabric considerably. Assuming a usual strength at rupture of the layer 2 or 3 at a level of 140 pli and a strength of the Kevlar reinforcing strip of 250 pli, the strength of the papermachine fabric at the positions 1′ to 6′ could be determined in a manner which emerges from the following table.

| | | | | | | |
|---|---|---|---|---|---|---|
| Position | 1′ | 2′ | 3′ | 4′ | 5′ | 6′ |
| Strength | 280 | 530 | 420 | 420 | 530 | 280 |
| (pli) | | | | | | |

It is clear that the transmission of the loadings from one end to the other increases with increasing length of the distance between the positions indicated. It is also clear that, with increasing adhesive strength, the distances between the individual positions can be shorter.

The mutual fusing of the free ends of the respective layer and, likewise, cutting off the projecting sections 15, 16 on the other side of the joint 10, can be carried out with the aid of a hot wire or with the aid of a heated knife or a heated blade. Furthermore, the mutual fusing or else the smoothing treatment of the mutually joined ends of the respective layer can be carried out with the aid of a vacuum bonding system with the application of heat and/or pressure.

With the aid of the method according to the invention, it is therefore possible to splice a multilayer papermachine fabric even on a paper machine without the thickness and the properties of the fabric changing disadvantageously in the region of the joints.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Charges may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

I claim:

1. A method for splicing a multilayer papermachine fabric comprising a first layer and a second layer wherein the first layer has a first and second free end and the second layer has a third and fourth free end, in which the free ends of the first layer and the free ends of the second layer are joined to each other at a first joint are and a second joint area, respectively, comprising the steps of:
(a) separating the first layer from the second layer in the region of the free ends;
(b) joining the first and second free ends by means of at least partial mutual fusing of the free ends and joining the third and fourth free ends by means of at least partial mutual fusing of the free ends;
(c) arranging a reinforcing strip covering the first joint are and the second joint area between the first and second layers; and
(d) mutually joining the reinforcing strip and the first and second layers.

2. The method as claimed in claim 1, wherein the mutual fusing of the free ends is carried out in step (b) by locally applying pressure and temperature, preferably a temperature of about 350° C.

3. The method as claimed in claim 2, wherein the applied temperature is about 350° C.

4. The method as claimed in claim 1, wherein the free ends are arranged with a first top side overlapping a second top side in order to carry out step (b).

5. The method as claimed in claim 1, wherein, when carrying out step (b), projecting sections of the free ends are removed.

6. The method as claimed in claim 1, wherein the ends joined to each other at the first and second joint area are subjected to a smoothing treatment before carrying out steps (c) and (d).

7. The method as claimed in claim 6, wherein the smoothing treatment is carried out by applying pressure and temperature by means of flat pressing the mutually joined ends in the first and second joint areas.

8. The method as claimed in claim 7, wherein the smoothing treatment is carried out by applying pressure and temperature by means of flat pressing the mutually joined ends in the first and second joint areas with renewed initial melting of the first and second layer in this region.

9. The method as claimed in claim 1, wherein the reinforcing strip comprises a polymeric aromatic aramide.

10. The method as claimed in claim 1, wherein the reinforcing strip comprises Kevlar®.

11. The method as claimed in claim 1, wherein the reinforcing strip has a thickness of about 90 μm.

12. The method as claimed in claim 1, wherein the first and second joint areas are offset by at least 7.5 cm from one another.

13. The method as claimed in claim 1, wherein the first and second layers are joined to each other by means of a perforated adhesive layer.

14. The method as claimed in claim 1, wherein the first and second layers are joined to each other by means of a perforated adhesive layer, the adhesive layer being carried by a carrier layer of BOPET.

15. The method as claimed in claim 14, wherein the carrier layer is Mylar®.

16. The method as claimed in claim 13, wherein the adhesive layer is laminated onto an upper side of the reinforcing strip and a hot-melt adhesive inlay is applied to an underside of the reinforcing strip in order to join the reinforcing strip to one of the first layer and the second layer.

17. The method as claimed in claim 1, wherein the reinforcing strip has an upper side and an underside, and wherein the reinforcing strip covers each of the first and second joint areas assigned to it on both the upper side and the underside by at least 7.5 cm.
